(19) United States
(12) Patent Application Publication
(10) Pub. No.: US 2005/0117514 A1
(43) Pub. Date: Jun. 2, 2005

(54) Communication system and communication terminal, communication-medium selection method used for the system and terminal, and program for the method

(75) Inventors: Mayumi Iwata, Tokyo (JP); Toshiaki Yagami, Tokyo (JP); Toshikazu Maruyama, Tokyo (JP); Saiko Goto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/995,401

(22) Filed: Nov. 24, 2004

(30) Foreign Application Priority Data
Nov. 28, 2003 (JP) 399252/2003

(51) Int. Cl. H04L 12/26

(52) U.S. Cl. 370/230

(57) ABSTRACT

In a communication terminal capable of selecting a communication medium best suited for the service settings and communicating via the selected medium, service executors include necessary applications and act as a trigger for the start of service provision. A communication controller has functions of detecting communication media, establishing connection therewith, selecting the most appropriate communication medium in response to service requests from the service executors, and performing communication. All communication between the service executors and communication nodes is performed via the communication controller, which acts as a proxy for the service executors. The communication controller sets and stores correspondence information between keywords contained in domain names and communication media to be used, between destination IP addresses and physical ports to be used, and between communication media and physical ports.

This application claims priority to prior application JP 2003-399252, the disclosure of which is incorporated herein by reference.

### BACKGROUND OF THE INVENTION

1. Field of the Invention

The present invention relates to communication systems and communication terminals, communication-medium selection methods used for the systems and terminals, and programs for the methods. Specifically, the present invention relates to a communication-medium selection method for appropriately using different communication media in a communication system where a plurality of communication media are available.

2. Description of the Related Art

With the development of communication environments, including mobile communication environments, there have been growing expectations for technologies for appropriately using a plurality of different communication media. Since the first priority in the development of communication systems has been given to establishing communication, technologies for appropriately using a plurality of different communication media have not yet been implemented due to concerns about an increase in communication costs.

For example, Japanese Unexamined Patent Publications Nos. 2003-163679 and 2003-289308 disclose systems that can ensure seamless communication, in the case when a communication terminal is moved in an environment where a plurality of communication media are available, by smoothly switching among the plurality of communication media depending on where the communication terminal currently is. The systems disclosed are intended to establish communication, and are not designed for appropriately using a plurality of different communication media.

However, it has become realistic to consider appropriately using a plurality of different communication media while being concurrently connected to the plurality of communication media, in the context of reducing communication costs for wired communication media, developing packet-switching methods for wireless communication media, and increasing flat-rate systems for wired/wireless communication media.

There are increasing numbers of cases where communication is performed for the needs of service providers, but not for the users of communication terminals. Examples include push delivery, advertising mail distribution, and online updating of software due to failures in communication terminals. It is unreasonable, in such cases, to perform all communication using communication media at the expense of the user of the communication terminal.

In known communication-medium selection methods, when available communication media are newly detected, a communication medium is selected, for switching and connecting to the medium, based on the attributes of the communication medium, such as communication costs, frequency bands, and radio intensity. Therefore, the communication medium is not selected based on the characteristics of service. That is, the communication medium to be used is not selected in view of the interests of the provision and use of service, such as the interests of service providers, the interests of service users, and the interests of both service providers and service users.

In the known communication-medium selection methods described above, selection of a communication medium, and switching and connection to the medium (disconnection of the current communication medium and connection to another communication medium) may be performed every time communication media are detected. This is disadvantageous in terms of the speed of service provision and the load imposed on a communication terminal and network apparatus at the time of connection.

In the known communication-medium selection methods, moreover, a communication medium is not selected in view of the characteristics of service, that is, the purpose of provision and use of the service for which communication is provided. Therefore, the communication medium is determined with some degree of uncertainty and may not be best suited for the service setting.

In the known communication-medium selection method, moreover, under the environment of communication terminal where a plurality of applications can be simultaneously used, the selected communication medium may not necessarily be best suited for all services provided by individual applications. Furthermore, the communication medium is not selected according to the frequency bands required for the service.

Conventionally, when a communication medium is selected in view of the purpose of provision and use of service, the determination of which communication medium to select is made, for each application, by the user of the communication terminal or by an application.

In the known communication-medium selection method described above, the determination of which communication medium to select needs to be made, for each application to be used, with the involvement of the user of the communication terminal or by modification of the application, in consideration of the available communication media. This is disadvantageous for rapid service provision in the today's dynamic environment for communication terminals, where online downloading of software can be performed and a plurality of different communication media are available depending on the location.

### SUMMARY OF THE INVENTION

Accordingly, an object of the present invention is to solve the problems described above and provide a communication system and communication terminal, a communication-medium selection method used for the system and terminal, and a program for the method, such that a communication medium can be appropriately selected according to the service setting and used for communication.

A communication system of the present invention is a communication system where a plurality of communication media are available between a communication terminal and communication nodes with which the communication terminal communicates, the nodes providing the communication terminal with various services. The communication terminal includes communication control means for selecting one of the plurality of communication media, the communication medium corresponding to a requested service, and communicating via the selected communication medium. The operation of the communication control means is independent of the operation of applications, each requesting the service.

A communication terminal of the present invention is provided with a plurality of communication media available for communicating with communication nodes providing the communication terminal with various services. The communication terminal includes communication control means for selecting one of the plurality of communication media, the communication medium corresponding to a requested service, and communicating via the selected communication medium. The operation of the communication control means is independent of the operation of applications, each requesting the service.

A communication-medium selection method of the present invention is a communication-medium selection method for selecting a communication medium corresponding to a service in a communication system where a plurality of communication media are available between a communication terminal and communication nodes with which the communication terminal communicates, the nodes providing the communication terminal with various services. The method includes a step of selecting one of the plurality of communication media, the communication medium corresponding to a requested service, and communicating via the selected communication medium. The operation in the step is independent of the operation of applications, each requesting the service.

A program of the present invention is a program for a communication-medium selection method for selecting a communication medium corresponding to a service in a communication system where a plurality of communication media are available between a communication terminal and communication nodes with which the communication terminal communicates, the nodes providing the communication terminal with various services. The program causes a communication terminal to execute the processing of selecting one of the plurality of communication media, the communication medium corresponding to a requested service, for communication via the selected communication medium; and causes the processing to be performed independent of the operation of applications, each requesting the service.

That is, in the communication system of the present invention, the communication terminal includes a communication controller for performing detection, connection, selection, and communication with respect to communication media; and service executors for executing applications. Since the communication controller determines which communication medium is to be used for executing which service, a method requiring no special function for each application and not affecting the applications can be implemented.

In the communication system of the present invention, information about a party with which an application desires to communicate (hereinafter referred to as “party”) is used to identify the service, which is the “use” of the communication system. Examples of the information about the party include an Internet protocol (IP) address of a node with which the application communicates (hereinafter referred to as “communication node”), and a uniform resource locator (URL) of the node for an application using the hyper text transfer protocol (HTTP).

The above-described communication controller stores a correspondence rule between information about parties and communication media appropriate for the parties, and selects an appropriate communication medium, based on the correspondence rule, in response to a request from each application in the service executors. A plurality of communication media appropriate for parties may be stored in order of priority.

Before selecting a communication medium, the communication controller detects available communication media, performs necessary connection processing with respect to the communication media, and keeps the communication media ready for communication. Since the communication controller assigns different global IP addresses to each port corresponding to each communication medium network, traffic from communication nodes can be divided into the appropriate communication medium network.

Moreover, the communication controller is concurrently connected to the plurality of communication media, queries the correspondence rule every time a request from an application is received, and directs the request to the most appropriate communication medium, thereby concurrently processing a plurality of applications each selecting a different communication medium.

The communication system of the present invention is assumed to be a network where domain names are used, in consideration of scalability. The communication system is characterized in that communication media best suited for respective services are selected for domain name system (DNS) packets to be sent and received before the services are provided.

This is particularly important in considering who is to be charged for the service to select the communication medium best suited for the party to communicate with. This is because any packets for services that are inconsistent with the intended purposes cannot be allowed to flow, for example, in the case where a user of a communication terminal prepares a communication medium to use a desired service and pays for the usage of the communication medium, or a communication node prepares another communication medium to provide a desired service and pays for the usage of the communication medium.

The communication system of the present invention provides, in an environment where a plurality of communication media are available to a communication terminal, a method for selecting, from the plurality of communication media, a communication medium appropriate for the characteristics of service.

Specifically, in the communication system of the present invention, the communication controller has functions of detecting a plurality of communication media, making connections to the plurality of communication media, identifying the use of communication according to the party to which the application desires to connect, selecting a communication medium best suited for the use of communication, and performing communication.

The communication system of the present invention is characterized in that the communication terminal stores different IP addresses for each communication medium, and uses a different IP address depending on the communication medium to be used, thereby directing traffic to appropriate communication medium. The communication system is also characterized in that communication media best suited for respective services are used in DNS processing that is performed before the services are provided.

In consideration of portable installation, the communication terminal in the communication system of the present invention is separated into the communication controller for performing detection, connection, selection, and communication with respect to communication media; and the service executors for executing applications. The communication controller and the service executors may be installed in the same housing, or in separate housings and communicate via a link.

The communication controller is capable of concurrently processing requests from the plurality of service executors and applications, selecting a communication medium best suited for each application, and performing communication. That is, the communication controller is capable of communicating by concurrently using the plurality of different communication media.

As described above, the communication terminal in the communication system of the present invention is separated into the communication controller and the service executors, and the communication controller selects communication media based on the identification of service providers. Therefore, there is no need for each application to determine which communication medium to select.

Thus, in the communication system of the present invention, the appropriate communication medium depending on the service requested by the application can be used without affecting the application, the network involved in the communication, and the environment of the party to communicate with. An effective method for selecting and using communication media can thus be achieved.

In the present invention, the following structure and operation are implemented for selecting an appropriate communication medium, depending on the service setting, to perform communication.

### BRIEF DESCRIPTION OF THE DRAWINGS

A more complete understanding of the invention may be obtained from a consideration of the following description in conjunction with the drawings in which

FIG. 1 is a block diagram showing the structure of a communication system according to an embodiment of the present invention.

FIG. 2 is a block diagram showing the structure of a communication terminal in FIG. 1.

FIG. 3A and FIG. 3B are sequence charts showing the operation of the communication system according to the embodiment of the present invention.

FIG. 4 is a flowchart showing the selection of communication media performed by a communication controller in FIG. 2.

FIGS. 5A to 5C show examples of stored information used in the operation of the communication system according to the embodiment of the present invention in FIGS. 3A and 3B.

FIGS. 6A to 6D show examples of messages used in the operation of the communication system according to the embodiment of the present invention in FIGS. 3A and 3B.

FIGS. 7A to 7D show examples of messages used in the operation of the communication system according to the embodiment of the present invention in FIGS. 3A and 3B.

FIG. 8 is a sequence chart showing the operation of the communication system according to the embodiment of the present invention.

FIGS. 9A and 9B show examples of stored information used in the operation of the communication system according to the embodiment of the present invention in FIG. 8.

FIGS. 10A to 10D show examples of messages used in the operation of the communication system according to the embodiment of the present invention in FIG. 8.

### DESCRIPTION OF THE PREFERRED EMBODIMENTS

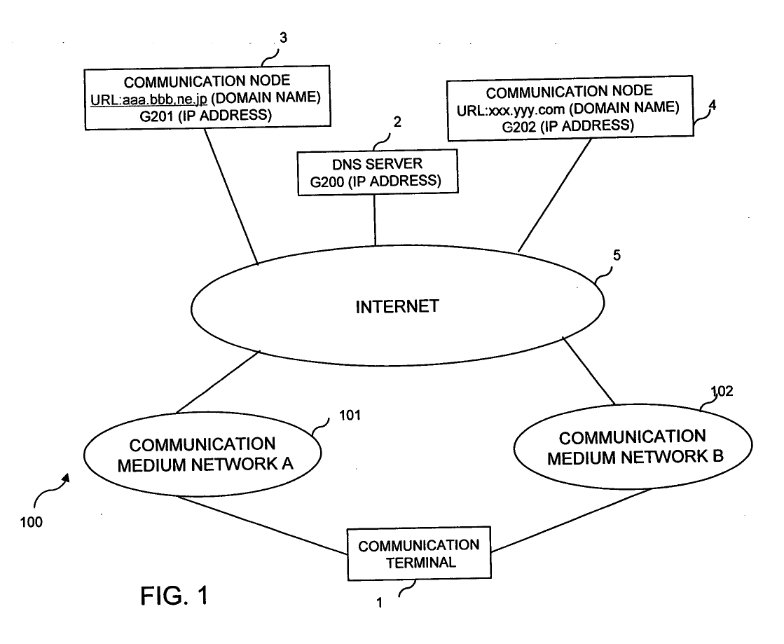

Embodiments of the present invention will now be described with reference to the drawings. FIG. 1 is a block diagram showing the structure of a communication system according to an embodiment of the present invention. The communication system of the present embodiment is based on the network where services are provided using HTTP, and where IP addresses and domain names of communication nodes are used as information for identifying services.

Referring to FIG. 1, a communication system according to an embodiment of the present invention includes a communication terminal 1, and an IP network 100 which includes the Internet 5, a communication medium network A 101, and a communication medium network B 102. A DNS server 2, a communication node 3, and a communication node 4 are provided on the Internet.

The DNS server 2 is given the IP address “G200”, while the communication node 3 is given the domain name “URL: aaa.bbb.ne.jp” and the IP address “G201”, and the communication node 4 is given the domain name “URL: xxx.yyy.com” and the IP address “G202”.

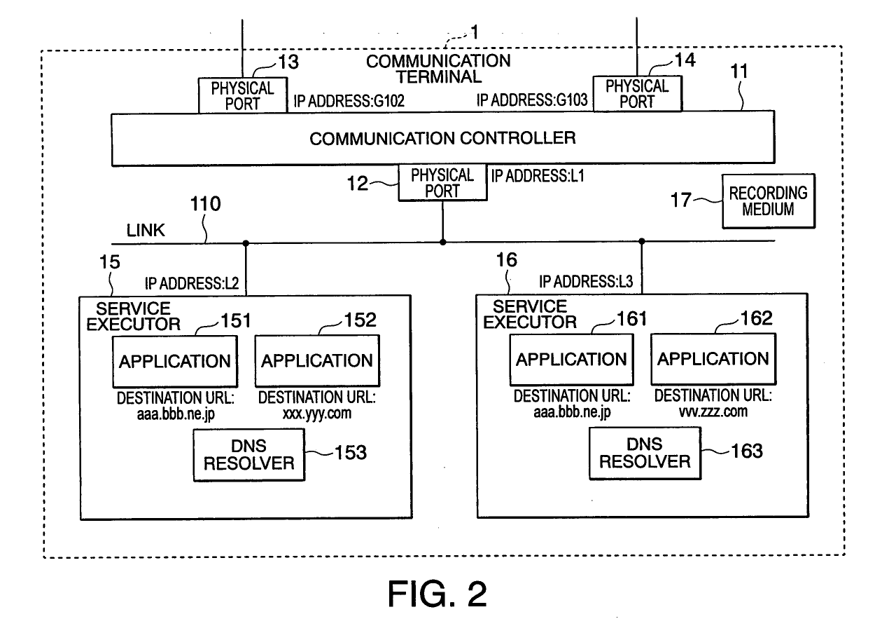

FIG. 2 is a block diagram showing the structure of the communication terminal 1 in FIG. 1. Referring to FIG. 1, the communication terminal 1 includes a communication controller 11, physical ports 12 to 14, service executors 15 and 16, and a recording medium 17 for storing data and programs (computer-executable programs) to be executed by the communication controller 11 and the service executors 15 and 16. The communication controller 11 communicates with the service executors 15 and 16 via a link 110.

The service executors 15 and 16 include necessary applications 151, 152, 161, and 162 and act as a trigger for the start of service provision. An arbitrary number of the service executors 15 and 16 can be provided.

The service executor 15 includes the applications 151 and 152, each using a URL to specify the party to communicate with, while the service executor 16 includes the applications 161 and 162, each using a URL to specify the party to communicate with.

The service executors 15 and 16 include DNS resolvers 153 and 163, respectively. The DNS resolvers 153 and 163 serve as client libraries for the applications 151, 152, 161, and 162 to translate host names into IP addresses.

Although not shown, the service executors 15 and 16 have functions of setting and storing IP addresses, by certain means, for use within the link 110. The IP addresses may be local IP addresses since they are used only within the link 110.

The communication controller 11 has functions of detecting communication media, establishing connection therewith, selecting the most appropriate communication medium in response to service requests from the service executors 15 and 16, and performing communication. All communication between the service executors 15 and 16 and the communication nodes 3 and 4 is performed via the communication controller 11, which acts as a proxy for the service executors 15 and 16.

Although not shown, the communication controller 11 has functions of setting and storing, by certain means, correspondence information between keywords contained in domain names and communication media to be used, between IP addresses to communicate with and physical ports to be used, and between the communication medium networkA 101 and communication medium network B 102 and the physical ports 13 and 14.

The correspondence information can have default settings to be used when no information corresponding to a search condition is found. In this example, the communication medium network A 101 and the communication medium network B 102 are best suited for the communication node 3 and the communication node 4, respectively.

The communication controller 11 also has functions of analyzing packets received from the service executors 15 and 16 to identify DNS packets, and parsing domain names included in the DNS packets.

The service executor 15 uses the physical port 12, the physical port 13, and the physical port 14 for the link 110, the communication medium network A 101, and the communication medium network B 102, respectively, and sets and stores IP addresses for the respective physical ports 12 to 14 by certain means. The IP address for the physical port 12 may be a local IP address since it is used only within the link 110. The IP addresses for the physical ports 13 and 14 may be global IP addresses or local IP addresses, depending on the environment of the IP network 100.

The communication terminal 1 communicates with the communication nodes 3 and 4 that provide services, and with the DNS server 2. The communication nodes 3 and 4 have domain names differing from service to service.

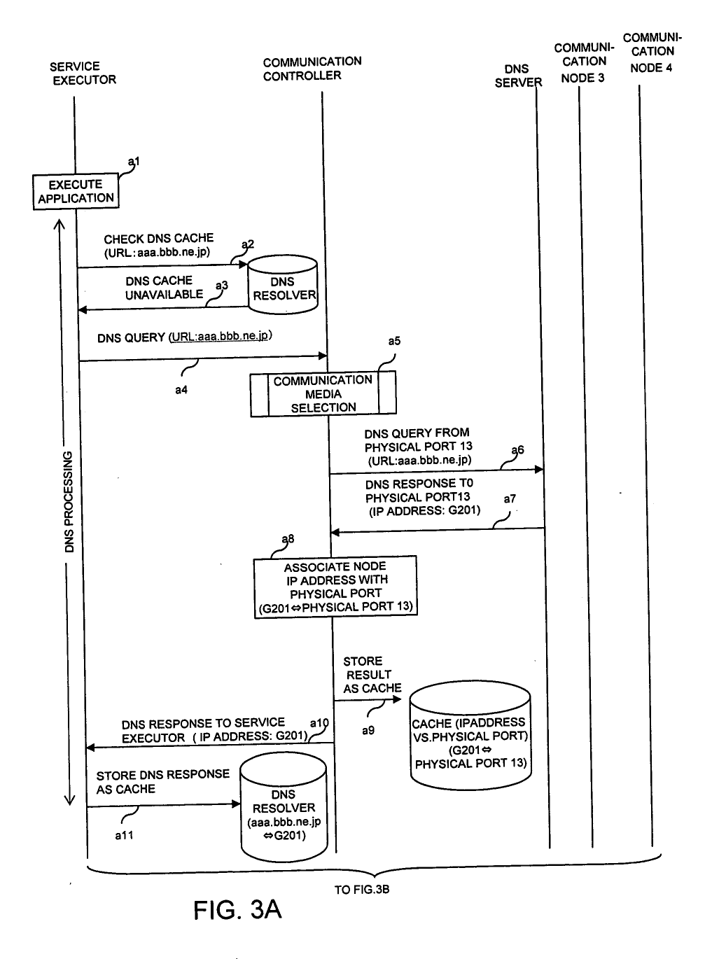

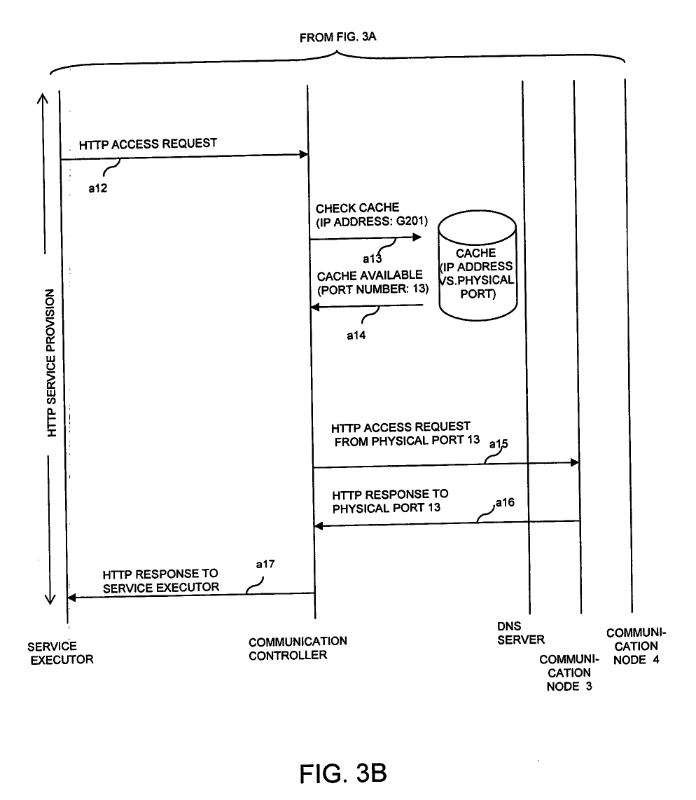

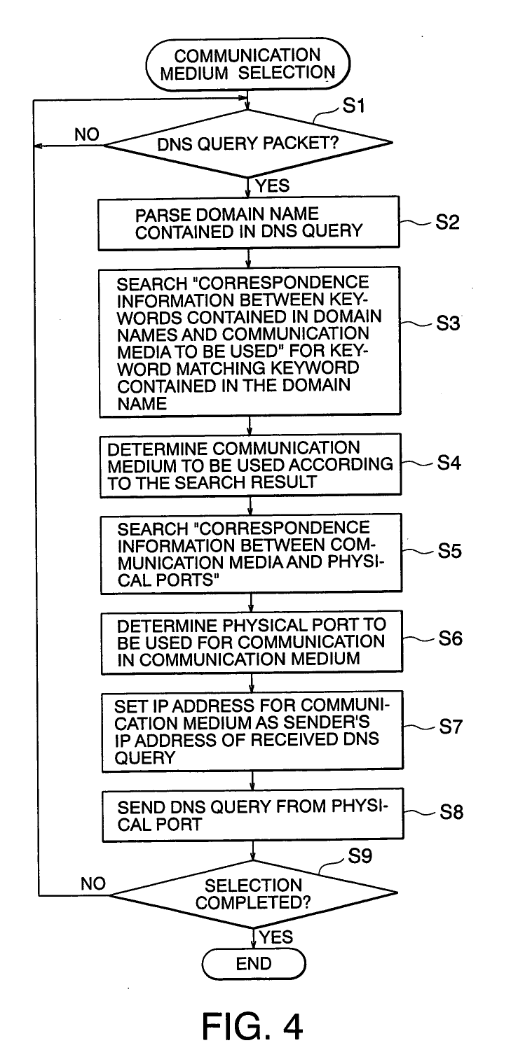

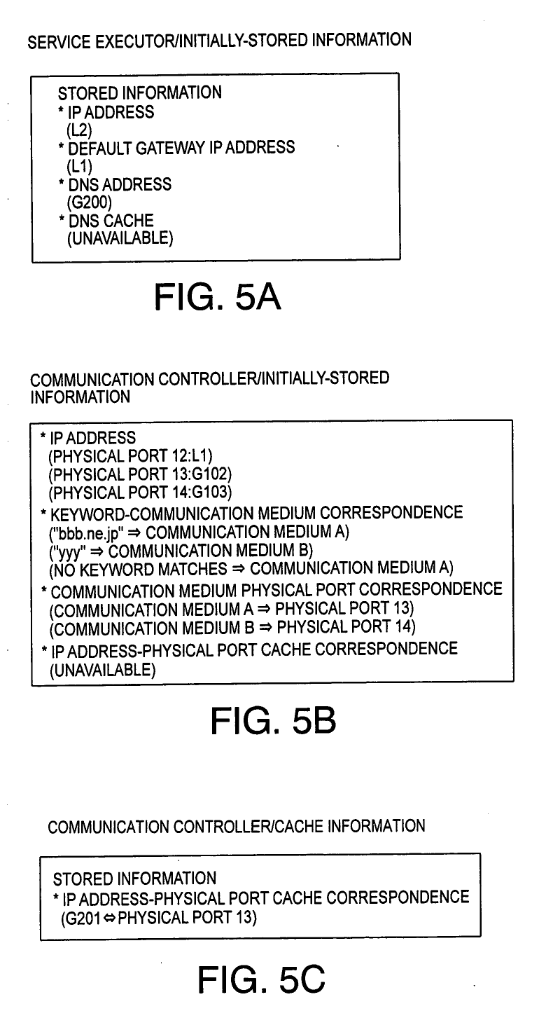

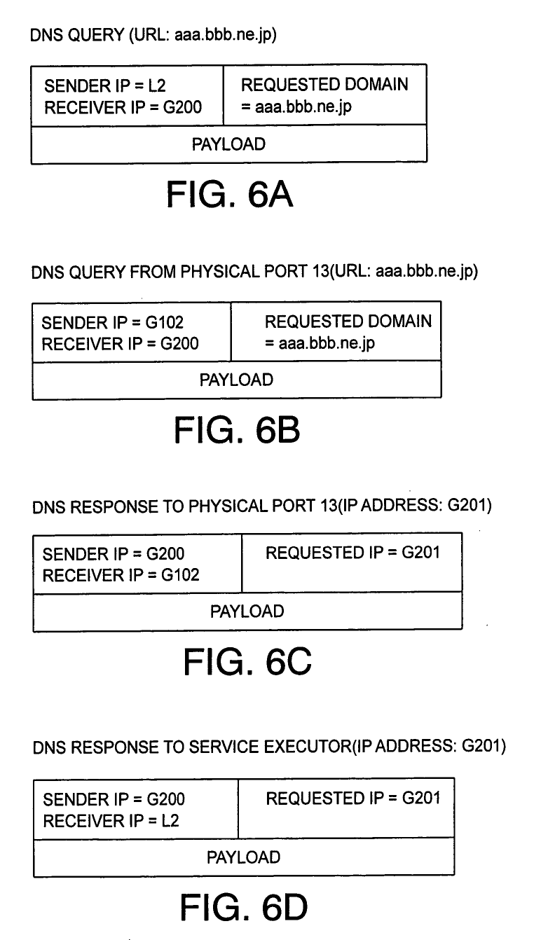

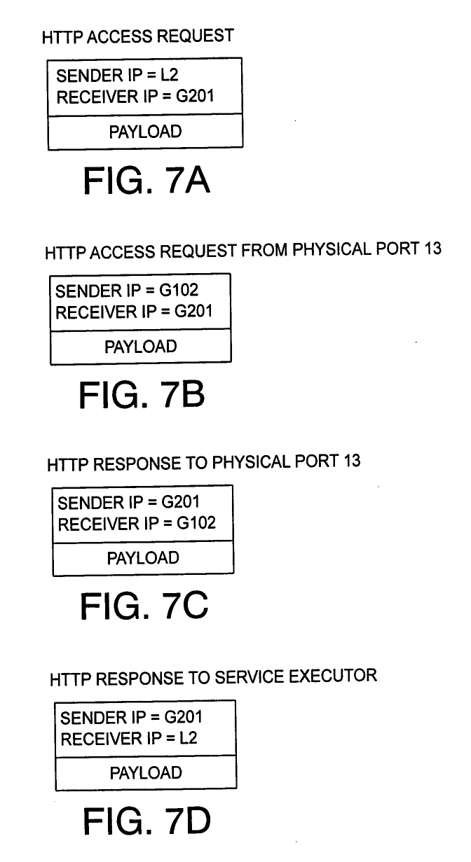

FIGS. 3A and 3B are a sequence chart showing the operation of the communication system according to the embodiment of the present invention. FIG. 4 is a flowchart showing the selection of communication media performed by the communication controller 11 in FIG. 2. FIGS. 5A to 5C show examples of stored information used in the operation of the communication system according to the embodiment of the present invention in FIGS. 3A and 3B. FIGS. 6A to 6D and FIGS. 7A to 7D show examples of messages used in the operation of the communication system according to the embodiment of the present invention in FIGS. 3A and 3B. In the following, while the descriptions will be made mainly on the service executor 15, similar ones are applicable to the service executor 16 with like information concerning the service executor 16. Thus, the description will be simplified of the service executor 16 below.

FIG. 5A shows initially-stored information in the service executors 15. In the settings, the IP address is “L2”, the default gateway IP address is “L1”, the DNS address is “G200”, and the DNS cache is “unavailable”. The initially-stored information in the service executor 16 differs from that in the service executor 15 in that “L3” is set as its IP address.

FIG. 5B shows initially-stored information in the communication controller 11. In the settings, the IP addresses are “physical port 12: L1”, “physical port 13: G102”, and “physical port 14: G103”; correspondence information between keywords and communication media is “bbb.ne.jp→communication medium A” and “yyy→communication medium B”; correspondence information between communication media and physical ports is “communication medium A→physical port 13” and “communication medium B→physical port 14”; and cache correspondence information between IP addresses and physical ports is “unavailable”. The default setting for the correspondence information between keywords and communication media is “no keyword matches→communication medium A”.

FIG. 5C shows initially-stored information in the communication nodes 3. In the settings, cache correspondence information between IP addresses and physical ports is “G201—physical port 13”. The initially-stored information in the communication node 4 and the DNS server 2 is “G202—physical port 14” and “G200—physical port 13”, respectively.

FIG. 6A shows an example of a message from the service executor 15 for a DNS query (URL: aaa.bbb.ne.jp). The settings for the message include “sender or source, IP=L2”, “receiver or destination IP=G200”, “requested domain name=aaa.bbb.ne.jp”, and “payload”.

FIG. 6B shows an example of a message for a DNS query (URL: aaa.bbb.ne.jp) from the physical port 13. The settings for the message include “sender IP=G102”, “receiver IP=G200”, “requested domain name=aaa.bbb.ne.jp”, and “payload”.

FIG. 6C shows an example of a message for a DNS response (IP address: G201) to the physical port 13. The settings for the message include “sender IP=G200”, “receiver IP=G102”, “requested IP=G201”, and “payload”.

FIG. 6D shows an example of a message for a DNS response (IP address: G201) to the service executors 15. The settings for the message include “sender IP=G200”, “receiver IP=L2”, “requested IP=G201”, and “payload”. A similar message format is used for service executor 16.

FIG. 7A shows an example of a message from the service executor 15 for an HTTP access request. The settings for the message include “sender IP=L2”, “receiver IP=G201”, and “payload”.

FIG. 7B shows an example of a message for an HTTP access request from the physical port 13. The settings for the message include “sender IP=G102”, “receiver IP=G201”, and “payload”.

FIG. 7C shows an example of a message for an HTTP response to the physical port 13. The settings for the message include “sender IP=G201”, “receiver IP=G102”, and “payload”.

FIG. 7D shows an example of a message for an HTTP response to the service executors 15. The settings for the message include “sender IP=G201”, “receiver IP=L2”, and “payload”. A similar message format also applies to the executor 16.

The operation of the communication system according to the embodiment of the present invention will now be described with reference to FIGS. 1 to 7D. The processing shown in FIG. 4 is performed by the communication controller 11 executing the program stored in the recording medium 17.

FIGS. 3A and 3B show the operation performed to use services provided by a party in the case where DNS resolution has not yet been performed and there is no correspondence information between the IP address of the party and a communication medium to be used.

The service executor 15 stores its IP address “L2” set, by certain means, for the link 110; the default gateway IP address “L1” set, by certain means, for the link 110; and the DNS IP address “G200” set by certain means (see FIG. 5A).

The default gateway IP address is the IP address of the communication controller 11 for the link 110, while the DNS IP address is the IP address of the DNS server 2. In the case where no corresponding DNS information has been generated by DNS resolution previously performed, no corresponding DNS cache information is stored.

The communication controller 11 stores its IP address “L1” set, by certain means, for the link 110; the IP address “G102” set, by certain means, for the communication medium network A 101; and the IP address “G103” set, by certain means, for the communication medium network B 102 (see FIG. 5B). “L1”, “G102”, and “G103” are used for communication performed in the physical port 12, the physical port 13, and the physical port 14, respectively.

The communication controller 11 also stores correspondence information between keywords contained in domain names and communication media to be used, such as “bbb.ne.jp uses communication medium network A 101” and “yyy uses communication medium network B 102”, set by certain means. The default setting for the correspondence information between keywords and communication media is “no keywords matches→communication medium A”.

The communication controller 11 also stores correspondence information between communication media and physical ports, such as “physical port 13 is used for communication medium network A 101” and “physical port 14 is used for communication medium network B 102”, set by certain means.

Correspondence information between destination IP addresses and physical ports to be used is generated and set as cache information at the time of DNS resolution according to the procedure described below (see FIG. 5c). No cache information generated by DNS resolution previously performed is stored at this point.

When the service executor 15 provides instructions to start executing the application 151 (a1 in FIG. 3), the sequence of use of services provided by the communication node 3 using HTTP is initiated. To request an access to the service provider URL aaa.bbb.ne.jp stored in the application 151, the service executor 15 starts up the DNS resolver 153 and queries the DNS resolver 153 for the IP address corresponding to the domain name “aaa.bbb.ne.jp” stored in the application 151 (a2 in FIG. 3A). Since no DNS cache information for “aaa.bbb.ne.jp” is stored (a3 in FIG. 3A), the service executor 15 creates and sends a DNS query addressed to the DNS server 2 to the link 110 (a4 in FIG. 3A).

When the DNS query is sent to the link 110, the communication controller 11 performs the selection of communication media (a5 in FIG. 3A). That is, when the DNS query from the service executor 15 is received at the physical port 12 for the link 110 (step S1 in FIG. 4), the communication controller 11 analyzes IP packets received at the physical port 12 on the local link side. If the packet is a DNS query packet, the communication controller 11 parses the domain name contained in the DNS query (step S2 in FIG. 4).

The communication controller 11 searches the correspondence information between keywords contained in domain names and communication media to be used for a keyword matching a keyword contained in the domain name (step S3 in FIG. 4) to determine the communication medium to be used according to the search result (step S4 in FIG. 4). Since the domain name included in the DNS query matches “bbb.ne.jp uses communication medium network A 101”, the communication controller 11 determines the communication medium network A 101 as the communication medium to be used.

The communication controller 11 searches the correspondence information between communication media and physical ports (step S5 in FIG. 4) to determine the physical port to be used for communication in the communication medium network A 101 (step S6 in FIG. 4). Since “physical port 13 is used for communication medium network A 101” is found, the communication controller 11 determines the physical port 13 as the physical port to be used.

Since the communication controller 11 has different IP addresses for the different communication media to be used, the communication controller 11 sets the IP address “G102” for the communication medium network A 101 as the sender's IP address of the received DNS query, and sends the DNS query from the physical port 13 to the DNS server 2 (a6 in FIG. 3A and step S8 in FIG. 4).

The DNS server 2 receives the DNS query sent to the IP address via the communication medium network A 101, translates the domain name “aaa.bbb.ne.jp” into the IP address “G201” of the communication node 3, and sends the DNS response to “G102” (a7 in FIG. 3A).

The communication controller 11 receives, via the communication medium network A 101, the DNS response from the DNS server 2 at the physical port 13. The communication controller 11 analyzes IP packets received at the physical port on the side of the communication medium network. If the IP packet received is a DNS response packet, the communication controller 11 generates information for associating the IP address contained in the payload of the DNS response with the physical port at which the DNS response packet has been received and sets the information as correspondence information between destination IP addresses and physical ports to be used.

This process enables normal IP packets, other than DNS packets, to select a physical port for a communication medium to be used only for an IP address of the destination, and eliminates the need for determining a communication medium or a physical port by parsing a domain name contained in a URL for each IP packet. Since the information, that is, the correspondence information between destination IP addresses and physical ports to be used, and DNS cache information stored in the service executor 15 are generated by the same trigger and associated with each other, synchronization between the correspondence information and the DNS cache information is required.

During the time when DNS cache information is present in the service executor 15, the correspondence information between destination IP addresses and physical ports to be used associated with the DNS cache information needs to exist in the communication controller 11. Therefore, the timing for the cache of the communication controller 11 to be cleared needs to be later than the timing for the cache of the service executor 15 to be cleared.

If a communication medium is disconnected, the cache of the communication controller 11 needs to be cleared since the correspondence information between communication media and physical ports is changed. In this case, the cache of the service executor 15 needs to be cleared before the cache of the communication controller 11 is cleared.

In the processing described above, the communication controller 11 stores “physical port 13 is used to communicate with G201” as the correspondence information between destination IP addresses and physical ports to be used (a8 in FIG. 3A) and sets it as cache information (a9 in FIG. 3A). Subsequently, in proxy processing, the communication controller 11 sets the IP address “L2” of the service executor 15 as the destination of the received DNS response, and sends the DNS response from the physical port 12 to the service executor 15 (a10 in FIG. 3A).

On receiving the DNS response, the service executor 15 stores “IP address for aaa.bbb.ne.jp is G201” as the DNS cache information (all FIG. 3A). Based on this DNS cache information, the service executor 15 sends an HTTP access request to the IP address “G201” of the communication node 3 (a12 in FIG. 3B).

The communication controller 11 receives the HTTP access request from the service executor 15 at the physical port 12 for the link 110. The communication controller 11 then analyzes the received IP packet. Since the IP packet is not a DNS packet, the communication controller 11 searches the correspondence information between destination IP addresses and physical ports to be used for the IP address “G201” of the destination of the HTTP access request (a13 in FIG. 3B).

In the case where the service executor 15 has obtained the IP address of the communication node 3 through the DNS packet processing described above, the IP address exists in the correspondence information between destination IP addresses and physical ports to be used in the communication controller 11 without exception. Here, the IP address “G201” of the destination is found in the “physical port 13 is used to communicate with G201” of the correspondence information between destination IP addresses and physical ports to be used (a14 in FIG. 3B). The communication controller 11 sets its IP address “G102” for the physical port 13 as the IP address of the sender of an HTTP access request and sends the HTTP access request from the physical port 13 (a15 in FIG. 3B).

The communication node 3 receives the HTTP access request sent via the communication medium network A 101 to its IP address and sends back the HTTP access response to the “G102” (a16 in FIG. 3B).

The communication controller 11 receives the HTTP access response, from the communication node 3 via the communication medium network A 101, at the physical port 13. In proxy processing, the communication controller 11 sets the IP address “L2” of the service executor 15 as the destination of the received HTTP access response, and sends the HTTP access response from the physical port 13 to the service executor 15 (a17 in FIG. 3B).

HTTP services are provided by the same processes as those in a12 to a17 in FIG. 3B. In the operation described above, a communication medium best suited for the service requested by the service executor 15 can be used, together with a DNS packet, to use the intended service.

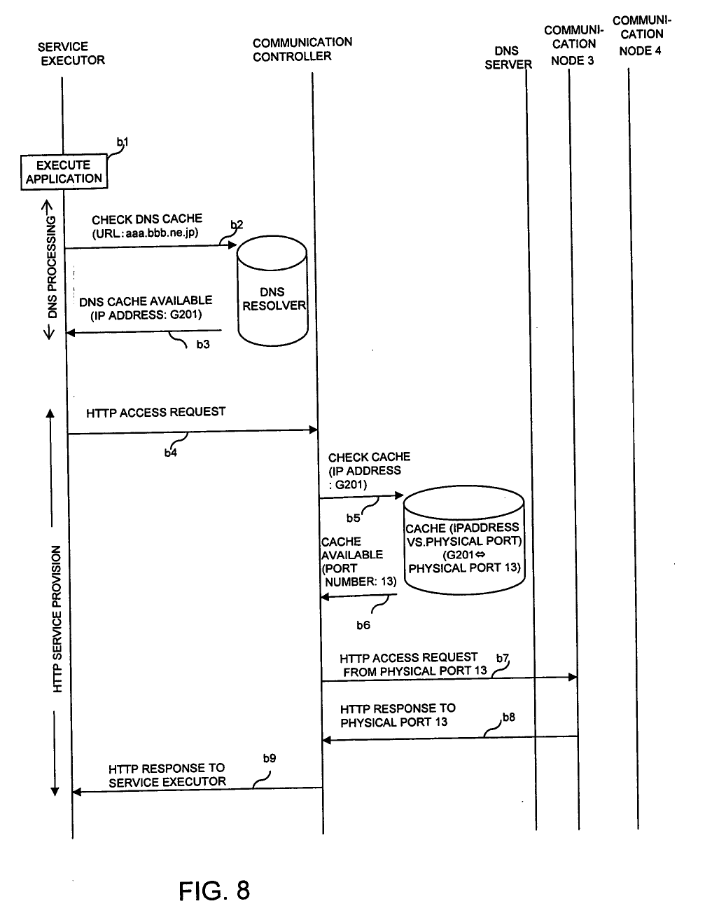

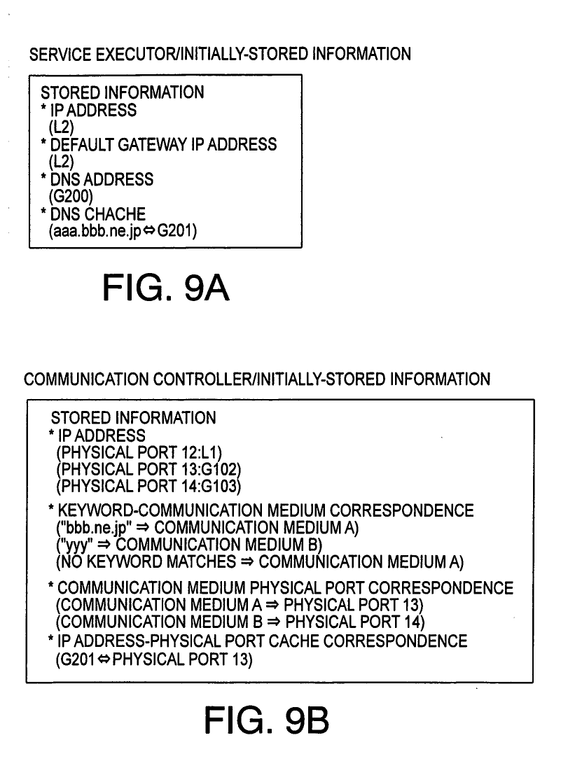

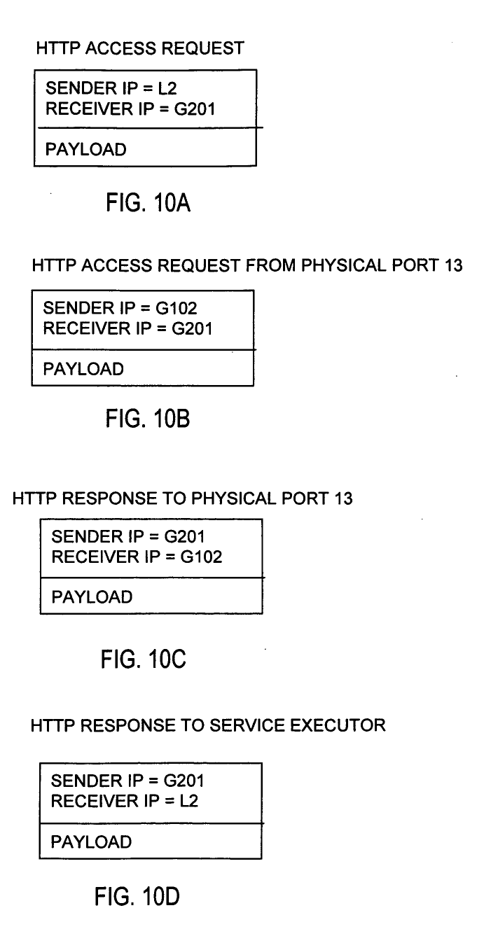

FIG. 8 is a sequence chart showing the operation of the communication system according to the embodiment of the present invention. FIGS. 9A and 9B show examples of stored information used in the operation of the communication system according to the embodiment of the present invention in FIG. 8. FIGS. 10A to 10D show examples of messages used in the operation of the communication system according to the embodiment of the present invention in FIG. 8.

FIG. 9A shows initially-stored information in the service executor 15. In the settings, the IP address is “L2”, the default gateway IP address is “L1”, the DNS address is “G200”, and the DNS cache is “aaa.bbb.ne.jp-G201”. The initially-stored information in the service executor 16 differs from that in the service executor 15 in that “L3” is set as its IP address.

FIG. 9B shows initially-stored information in the communication controller 11. In the settings, the IP addresses are “physical port 12: L1”, “physical port 13: G102”, and “physical port 14: G103”; correspondence information between keywords and communication media is “bbb.ne.jp→communication medium A” and “yyy→communication medium B”; correspondence information between communication media and physical ports is “communication medium A→physical port 13” and “communication medium B→physical port 14”; and cache correspondence information between IP addresses and physical ports is “G201—physical port 13”. The default setting of the correspondence information between keywords and communication media is “no keyword matches→communication medium A”, which is set by certain means.

FIG. 10A shows an example of a message from the service executor 15 ++for an HTTP access request. The settings for the message include “sender IP=L2”, “receiver IP=G201”, and “payload”.

FIG. 10B shows an example of a message for an HTTP access request from the physical port 13. The settings for the message include “sender IP=G102”, “receiver IP=G201”, and “payload”.

FIG. 10C shows an example of a message for an HTTP response to the physical port 13. The settings for the message include “sender IP=G201”, “receiver IP=G102”, and “payload”.

FIG. 10D shows an example of a message for an HTTP response to the service executors 15. The settings for the message include “sender IP=G201”, “receiver IP=L2”, and “payload”.

The operation of the communication system according to the embodiment of the present invention will now be described with reference to FIGS. 1 and 2, and FIGS. 8 to 10D. FIG. 8 shows the operation performed to use services provided by a party in the case where correspondence information between the IP address of the party and a communication medium to be used is present because of DNS resolution performed as described above.

The service executor 15 stores its IP address “L2” set, by certain means, for the link 110; the default gateway IP address “L1” set, by certain means, for the link 110; and the DNS IP address “G200” set by certain means.

The default gateway IP address is the IP address of the communication controller 11 for the link 110, while the DNS IP address is the IP address of the DNS server 2. By the DNS resolution described above, “IP address for aaa.bbb.ne.jp is G201” is stored as the DNS cache information (see FIG. 9A).

The communication controller 11 stores its IP address “L1” set, by certain means, for the link 110; the IP address “G102” set, by certain means, for the communication medium network A 101; and the IP address “G103” set, by certain means, for the communication medium network B 102. “L1”, “G102”, and “G103” are used for communication performed in the physical port 12, the physical port 13, and the physical port 14, respectively.

The communication controller 11 also stores correspondence information between keywords contained in domain names and communication media to be used, such as “bbb.ne.jp uses communication medium network A 101” and “yyy uses communication medium network B 102”, set by certain means.

The communication controller 11 also stores correspondence information between communication media and physical ports such as “physical port 13 is used for communication medium network A 101” and “physical port 14 is used for communication medium network B 102”, set by certain means.

By the DNS resolution described above, the communication controller 11 also stores “communication with G201 is performed at physical port 13” as correspondence information between destination IP addresses and physical ports to be used (see FIG. 9B).

When the service executor 15 executes the application 151 (b1 in FIG. 8), the sequence of use of services provided by the communication node 3 using HTTP is initiated. The service executor 15 queries the DNS resolver 153 for the IP address corresponding to the domain name “aaa.bbb.ne.jp” stored in the application 151 (b2 in FIG. 8). Since the query matches the DNS cache information “IP address for aaa.bbb.ne.jp is G201” (b3 in FIG. 8), the service executor 15 creates an HTTP access request addressed to the IP address “G201” of the communication node 3 and sends the request to the link 110 (b4 in FIG. 8).

The communication controller 11 receives the HTTP access request from the service executor 15 at the physical port 12 for the link 110. The communication controller 11 then analyzes the received IP packet. Since the IP packet is not a DNS packet, the communication controller 11 searches the correspondence information between destination IP addresses and physical ports to be used for the IP address “G201” of the destination of the HTTP access request (b5 in FIG. 8).

In the case where the service executor 15 has obtained the IP address of the communication node 3 through the DNS packet processing described above, the IP address exists in the correspondence information between destination IP addresses and physical ports to be used in the communication controller 11 without exception. Here, “G201” is found in the “physical port 13 is used to communicate with G201” of the correspondence information between destination IP addresses and physical ports to be used (b6 in FIG. 8). The communication controller 11 sets its IP address “G102” for the physical port 13 as the IP address of the sender of an HTTP access request and sends the HTTP access request from the physical port 13 to the communication node 3 (b7 in FIG. 8).

The communication node 3 receives the HTTP access request sent via the communication medium network A 101 to its IP address and sends back the HTTP access response to the “G102” (b8 in FIG. 8).

The communication controller 11 receives the HTTP access response, from the communication node 3 via the communication medium network A 101, at the physical port 13. In proxy processing, the communication controller 11 sets the IP address “L2” of the service executor 15 as the destination of the received HTTP access response, and sends the HTTP access response from the physical port 12 (b9 in FIG. 8). HTTP services are provided by the same processes as those in b4 to b9 in FIG. 8.

As described in the embodiment, the present invention is based on the precondition that the service to be provided and communication medium to be used are predetermined such that the correspondence between the service and the medium is appropriate for the characteristics of the service. In practice, a user or service provider determines the appropriate communication medium depending on the characteristics of the service. Specifically, based on the determination, for example, the service provider configures the communication terminal before shipment, the service provider configures the communication terminal online, the user configures the communication terminal using functions in the communication terminal, or the combination of these is performed. Examples of the characteristics of service include frequency bands required by the service, and who is to pay the communication fee.

As examples of communication media, a wireless LAN and mobile phone network may be used as the communication medium network A 101 and communication medium network B 102, respectively.

In the present embodiment, the characteristics of the services to be provided are identified by information about the parties with which the applications 151, 152, 161, and 162 desire to communicate. The communication media truly required for the service settings can thus be selected.

Moreover, in the present embodiment, the communication controller 11 is concurrently connected to the plurality of communication media, queries the correspondence rule every time requests from the respective applications 151, 152, 161, and 162 are received, and directs each request to the most appropriate communication medium. Services can thus be concurrently provided to the plurality of applications 151, 152, 161, and 162 by using the most appropriate communication media. In this case, the communication controller 11 having a different IP address for each communication medium uses a different IP address for each medium.

Moreover, in the present embodiment, before services are provided in the IP network 100 where domain names are used, DNS packets can also be sent and received via the selected communication media best suited for the respective services. Since communication media are selected based on the characteristics of the service to be provided, the communication fee can be appropriately charged to, for example, users of the communication terminal or service providers, depending on the selection.

In the present embodiment, moreover, in the network where domain names are used, only the DNS processing needs to query high-layer information about the parties so as to select a communication medium. Since such processing is unnecessary for normal IP packet processing, the load imposed on the communication terminal 1 can be reduced.

Since the communication controller 11 and the service executors 15 and 16 are separated in the present embodiment, no special processing is required for the applications 151, 152, 161, 162, the network involved in the communication, and the communication nodes 3 and 4. The above-described effects can thus be implemented without affecting the operation of the user of the communication terminal 1, each of the applications 151, 152, 161, and 162, and the communication nodes 3 and 4.

Although the IP address of the party with which to communicate is used as information about the party in the present embodiment, the present invention is also applicable to the case where, for example, a destination port number of transmission control protocol/user datagram protocol (TCP/UDP), IP protocol number, session ID, or URL is used.

Although a network where domain names are used has been described in the present embodiment, the present invention is also applicable to a network where domain names are not used, by setting the correspondence information between destination IP addresses and physical ports to be used in the communication controller through certain means other than by DNS processing.

Moreover, in the present invention, the correspondence information in the communication controller may be stored in other ways. For example, correspondence information between destination IP addresses and communication media to be used instead of the correspondence information between destination IP addresses and physical ports to be used may be stored. Then, based on the determined communication medium, the correspondence information between destination IP addresses and communication media to be used is searched to determine the physical port.

In the present embodiment, moreover, the above-described embodiment is applicable to the case where the communication terminal and the service executors are installed in the same housing.

While in the above embodiment the DNS server 2, communication nodes 3 and 4 have been on the Internet, they may on networks using IP protocol.

Although the invention is described herein with reference to the preferred embodiments, one skilled in the art will readily appreciate that other applications may be substituted for those set forth herein without departing from the spirit and scope of the present invention. Accordingly, the invention should only be limited by the claims included below.

1. A communication system where a plurality of communication media are available between a communication terminal and communication nodes with which the communication terminal communicates, the nodes providing the communication terminal with various services, the communication terminal comprising:
a communication controller for selecting one of the plurality of communication media, the communication medium corresponding to a requested service, and communicating via the selected communication medium; wherein
the operation of the communication controller is independent of the operation of applications, each requesting the service.

2. The communication system according to claim 1, wherein the communication controller selects the communication medium based on information about one of the communication nodes with which the application desires to communicate.

3. The communication system according to claim 2, wherein the communication controller stores a correspondence rule between the information about the communication nodes and the communication media appropriately suited for the communication nodes so as to select one of the communication media based on the correspondence rule.

4. The communication system according to claim 3, wherein the correspondence rules include correspondence information between keywords contained in domain names and the communication media to be used.

5. The communication system according to claim 3, wherein the communication controller stores the correspondence rule in which the plurality of communication media are arranged in order of priority.

6. The communication system according to claim 1, wherein the communication controller detects the available communication media before selecting one of the communication media, performs necessary connection processing with respect to the communication media, and keeps the communication media ready for communication.

7. The communication system according to claim 3, wherein the communication controller is concurrently connected to the plurality of communication media, queries the correspondence rule every time a request from each application is received, and directs the request to any of the plurality of communication media.

8. The communication system according to claim 1, wherein, in a network where domain names are used, one of the communication media is selected for a DNS packet to be sent and received before the services are provided.

9. The communication system according to claim 1, the communication terminal further comprising executor for executing the applications, the executor being independent of the communication controller.

10. The communication system according to claim 9, wherein the communication controller and the executor are installed in the same housing.

11. The communication system according to claim 9, wherein the communication controller and the executor are installed in separate housings and communicate via a link.

12. A communication terminal being provided with a plurality of communication media available for communicating with communication nodes providing the communication terminal with various services, the communication terminal comprising:
communication controller for selecting one of the plurality of communication media, the communication medium corresponding to a requested service, and communicating via the selected communication medium; wherein
the operation of the communication controller is independent of the operation of applications, each requesting the service.

13. The communication terminal according to claim 12, wherein the communication controller selects the communication medium based on information about one of the communication nodes with which the application desires to communicate.

14. The communication terminal according to claim 13, wherein the communication controller stores a correspondence rule between the information about the communication nodes and the communication media best suited for the communication nodes so as to select one of the communication media based on the correspondence rule.

15. The communication terminal according to claim 14, wherein the correspondence rules include correspondence information between keywords contained in domain names and the communication media to be used.

16. The communication terminal according to claim 14, wherein the communication controller stores the correspondence rule in which the plurality of communication media are arranged in order of priority.

17. The communication terminal according to claim 12, wherein the communication controller detects the available communication media before selecting one of the communication media, performs necessary connection processing with respect to the communication media, and keeps the communication media ready for communication.

18. The communication terminal according to claim 14, wherein the communication controller is concurrently connected to the plurality of communication media, queries the correspondence rule every time requests from the respective applications are received, and directs each request to one of the plurality of communication media.

19. The communication terminal according to claim 12, wherein, in a network where domain names are used, one of the communication media is selected for a DNS packet to be sent and received before the services are provided.

20. The communication terminal according to claim 12, further comprising executor for executing the applications, the executor being independent of the communication controller.

21. The communication terminal according to claim 20, wherein the communication controller and the executor are installed in the same housing.

22. The communication terminal according to claim 20, wherein the communication controller and the executor are installed in separate housings and communicate via a link.

23. A communication-medium selection method for selecting a communication medium corresponding to a service in a communication system where a plurality of communication media are available between a communication terminal and communication nodes with which the communication terminal communicates, the nodes providing the communication terminal with various services, the method comprising:
a step of selecting one of the plurality of communication media, the communication medium corresponding to a requested service, and communicating via the selected communication medium; wherein
the operation in the communication media selecting step is independent of the operation of applications, each requesting the service.

24. The communication-medium selection method according to claim 23, wherein the communication media selecting step selects the communication medium based on information about one of the communication nodes with which the application desires to communicate.

25. The communication-medium selection method according to claim 24, wherein the communication media selecting step includes a step of storing a correspondence rule between the information about the communication nodes and the communication media appropriately suited for the communication nodes so as to select one of the communication media based on the correspondence rule.

26. The communication-medium selection method according to claim 25, wherein the correspondence rules include correspondence information between keywords contained in domain names and the communication media to be used.

27. The communication-medium selection method according to claim 25, wherein the communication media selecting step include a step of storing the correspondence rule in which the plurality of communication media are arranged in order of priority.

28. The communication-medium selection method according to claim 23, wherein the communication media selecting step include steps of detecting the available communication media before selecting one of the communication media, performing necessary connection processing with respect to the communication media, and keeping the communication media ready for communication.

29. The communication-medium selection method according to claim 25, wherein the communication media selecting step include steps of concurrently connecting to the plurality of communication media, querying the correspondence rule every time requests from the respective applications are received, and directing each request to one of the plurality of communication media.

30. The communication-medium selection method according to claim 23, wherein, in a network where domain names are used, one of the communication media is selected for a DNS packet to be sent and received before the services are provided.

31. A program for a communication-medium selection method for selecting a communication medium corresponding to a service in a communication system where a plurality of communication media are available between a communication terminal and communication nodes with which the communication terminal communicates, the nodes providing the communication terminal with various services, the program for:
causing a computer to execute the processing of selecting one of the plurality of communication media, the communication medium corresponding to a requested service, for communication via the selected communication medium; and
causing the processing to be performed independent of the operation of applications, each requesting the service.

32. Software stored on a computer readable medium for selecting a communication medium corresponding to a service in a communication system where a plurality of communication media are available between a communication terminal and communication nodes with which the communication terminal communicates, the nodes providing the communication terminal with various services, the software for causing a computer to perform a function of:
executing the processing of selecting one of the plurality of communication media, the communication medium corresponding to a requested service, for communication via the selected communication medium in such a way that the processing to be performed is independent of the operation of applications, each requesting the service.

33. A communication system where a plurality of communication media are available between a communication terminal and communication nodes with which the communication terminal communicates, the nodes providing the communication terminal with various services, the communication terminal comprising:
a service requester requesting the services, the requester including a plurality of applications having address information corresponding to the nodes; and
a communication controller connected to the service requester via a link segment, wherein
the communication controller stores data defining the correspondence between information about the nodes and information about the communication media corresponding to the information about the nodes, and, in response to the startup of each application, selects one of the communication media from the data, based on the address information transferred from the service requester, to communicate.

34. A communication terminal being provided with a plurality of communication media available for communicating with communication nodes providing the communication terminal with various services, the communication terminal comprising:
a service requester requesting the services, the requester including a plurality of applications having address information corresponding to the nodes; and
a communication controller connected to the service requester via a link segment, wherein
the communication controller stores data defining the correspondence between information about the nodes and information about the communication media corresponding to the information about the nodes, and, in response to the startup of each application, selects one of the communication media from the data, based on the address information transferred from the service requester, to communicate.
